(19) United States
(12) Patent Application Publication
(10) Pub. No.: US 2006/0238235 A1
(43) Pub. Date: Oct. 26, 2006

(54) Switchable current mirror with feedback

(76) Inventors: James Wey, Arlington, MA (US); Geoffrey Haigh, Boxford, MA (US)

Correspondence Address: BROMBERG & SUNSTEIN LLP, 125 SUMMER STREET, BOSTON, MA, 02110-1618, US

(21) Appl. No.: 11/335,836

(22) Filed: Jan. 19, 2006

Related U.S. Application Data
(60) Provisional application No. 60/644,956, filed on Jan. 19, 2005.

(51) Int. Cl. G05F 1/10

(52) U.S. Cl. 327/543

(57) ABSTRACT

In one embodiment of the invention, a switchable output current mirror with feedback is disclosed. The current mirror includes a master stage, a slave stage, and an operational amplifier that is coupled in a feedback loop with the master stage. A reference current is introduced at an input node of the current mirror. The input node is coupled to an input terminal of the operational amplifier and to a current source of the master stage. The output of the operational amplifier electrically couples to the master stage to control the current source of the master stage. The slave stage of the current mirror includes a current source that receives the output from the output terminal of the operational amplifier to control the current source. The slave stage also includes a switch for receiving a control signal and selectively coupling the current source of the slave stage with the output of the current mirror. The master stage may include a switch that is controllable by a control signal. The switch may have a plurality of outputs and each of the outputs is coupled to one of the input terminals of the operational amplifier.

### CROSS REFERENCE TO RELATED APPLICATIONS

The present application claims priority from U.S. Provisional Patent Application No. 60/644,956 filed on Jan. 19, 2005 entitled “Switchable Current Mirror with Feedback,” which is incorporated herein by reference in its entirety.

### TECHNICAL FIELD AND BACKGROUND ART

The present invention relates to current mirrors and more specifically to current mirrors with linearizing feedback.

It is known in the prior art to create a replica current, often called, a current mirror as shown in FIG. 1. The output current is almost equal to the input current; however the output current differs due to the finite base currents of the transistors. The output current is approximately

$${I}_{out} = \frac{1}{1 + 2 / β} {I}_{i n} .$$

In another current mirror, an emitter-follower buffer Q3 is added to the current mirror in order to supply the base currents resulting in an output current Iₒᵤₜ=Iᵢₙ(1−2/β²). The additional transistor minimizes the errors due to finite base currents. Additionally, there are other variations for improving the linearity of the circuit including emitter degeneration for minimizing the transistor mismatches. However, each of these variations still results in a differential between the input current and the output current and is a less than ideal solution for testing equipment applications. Further, these applications are not switchable nor do they provide different output current levels from the input current level.

### SUMMARY OF THE INVENTION

In one embodiment of the invention, a switchable output current mirror with feedback is disclosed. The current mirror includes a master stage, a slave stage, and an operational amplifier that is coupled in a feedback loop with the master stage. A reference current is introduced at an input node of the current mirror. The input node is coupled to an input terminal of the operational amplifier and to a current source of the master stage. The output of the operational amplifier electrically couples to the master stage to control the current source of the master stage. The slave stage of the current mirror includes a current source that receives the output from the output terminal of the operational amplifier to control the current source. The slave stage also includes a switch for receiving a control signal and selectively coupling the current source of the slave stage with the output of the current mirror. The master stage may include a switch that is controllable by a control signal. The switch may have a plurality of outputs and each of the outputs is coupled to one of the input terminals of the operational amplifier.

In other embodiments, the slave stage comprises a plurality of sub-circuits wherein each sub-circuit includes a current source coupled to the operational amplifier and each sub-circuit also includes a switch for switching between at least a first and a second output state. By including multiple sub-circuits in the slave stage, different output currents from the current mirror are achieved by switching one or more of the sub-circuits to the output of the current mirror. For example, the output current may be 1×, 3×, or 5× the input reference current. The current mirror may also include control logic that produces a control signal for selection of one or more the current sources of the sub-circuits to be electrically coupled to the output of the current mirror.

In another embodiment, the output current may differ from the input reference current by varying the size of the transistors defining the current source within the master and slave stages. For example, the current at the output may be 10× the input reference current by sizing the one or more transistors of a current source in the slave stage to be 10× the size of the transistor within the current source of the master stage.

The switches within the master stage and the slave stage may be differential transistor pairs, such as bipolar pairs or field effect transistor pairs. If the switches are differential switches the control signal to the switches will be a differential signal.

In certain embodiments, the current source of a sub-circuit of the slave stage may be switched so that the current source is present within the feedback loop of the master stage. In a different state of the switch for the sub-circuit, the current source of the sub-circuit will be coupled to the output of the current mirror and contribute to the current at the output of the current mirror.

In another embodiment, the current mirror may include a master stage and a slave stage. In such a configuration, the master stage includes an input for receiving an input current, a current source controlled by a current source signal, and a differential switching pair having an output which is fed back to the input. The slave stage includes a current source controlled by the current source signal and at least one differential switching pair including at least one output wherein current output from the slave stage is equal to a multiple of the input current. The current mirror further includes an operational amplifier having an output electrically coupled to the current sources of the master and slave stages.

In certain embodiments, the current source of the master and slave stages each include a bi-polar transistor and the output of the operational amplifier is coupled to the base of both bi-polar transistors. The differential switching pair receives a control signal for either directing current from the current source of the slave stage either to a current mirror output or to a location internal to the current mirror.

A method for selecting an output current of a switchable current mirror is also described. The current mirror of such method includes an operational amplifier, a master stage including a switch, and a slave stage having a plurality of sub-circuits. Each sub-circuit of the slave stage also includes a switch. First, a reference current is provided to an input terminal of the operational amplifier. A feedback signal is generated and fed back from the master stage to the input of the operational amplifier. The output of the operational amplifier is provided as a voltage control signal to a current source of the master stage and to the current sources of each sub-circuit of the slave stage. A switch of the one or more sub-circuits is controllably switched, so that a current source of the one or more sub-circuits are electrically coupled to an output of the current mirror. In certain embodiments, a control signal is provided to one or more switches in the sub-circuits for switching at least one of the sub-circuits of the slave stage, so that the at least one sub-circuit contributes to the feedback signal.

### BRIEF DESCRIPTION OF THE DRAWINGS

The foregoing features of the invention will be more readily understood by reference to the following detailed description, taken with reference to the accompanying drawings, in which:

FIG. 1 is a prior art current mirror;

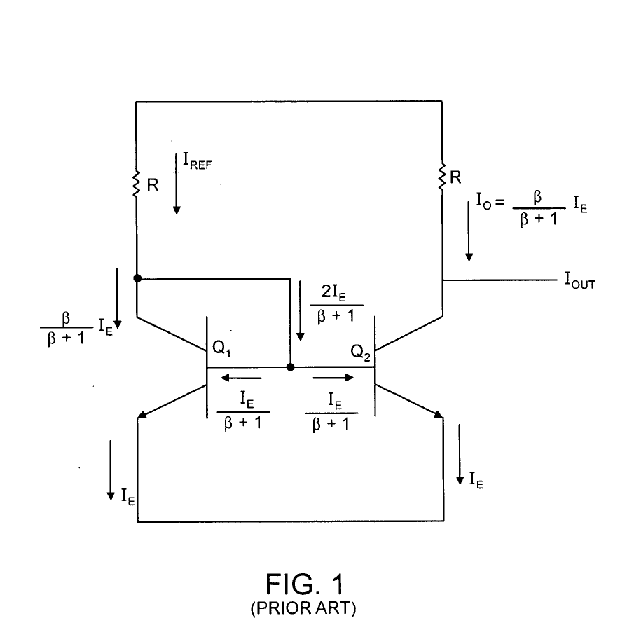

FIG. 2 is a block diagram of a switchable current mirror with feedback;

FIG. 3 is a circuit schematic showing a first embodiment of a switchable current mirror with feedback;

FIG. 4 is a circuit schematic showing a second embodiment of a switchable current mirror with feedback; and

FIG. 5 is a flow chart for switching the current in a switchable current mirror with feedback.

### DETAILED DESCRIPTION OF SPECIFIC EMBODIMENTS

In one embodiment, the invention is directed to a switchable current mirror that can be switched at nano-second speeds. In addition, the circuit includes a feedback loop that linearizes the mirrored current. The switchable current mirror may switch in one of two ways. In the first switching embodiment, the current mirror may switch between a plurality of separate outputs. In the second switching embodiment, there are a plurality of output stages that may be switched, so that the output stages are electrically coupled to the output and the current produced by these stages sum at the current mirror output. Additionally, a switchable current mirror may be constructed that includes both forms of switching.

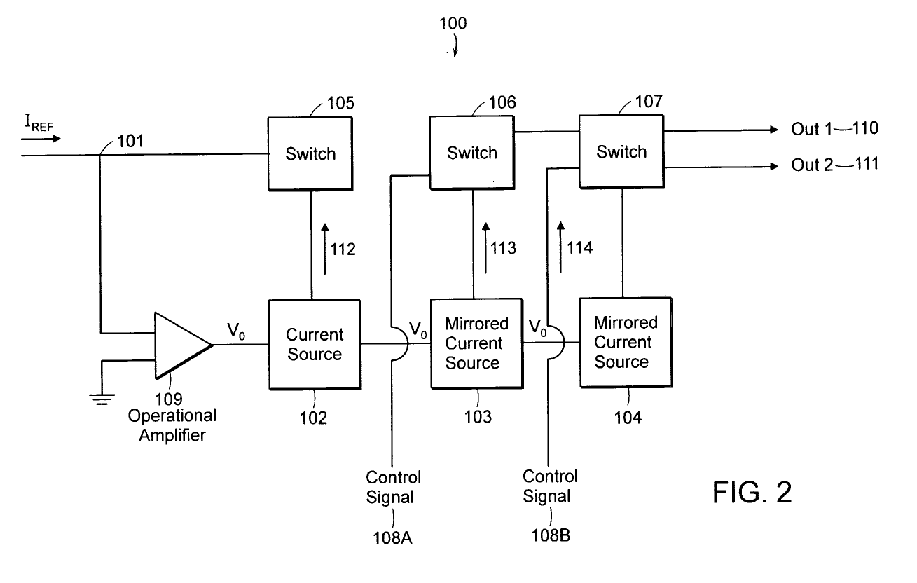

FIG. 2 is a block diagram of a switchable current mirror with feedback 100. The current mirror includes a first current source 102 producing a current that is mirrored in one or more other current sources 103, 104. In the figure, only two mirrored current sources 103, 104 are shown, but more than two mirrored current sources may be present in the circuitry; and the two mirrored current sources are presented only for exemplary purposes. The mirrored current sources 103, 104 either provide their current to an output of the current mirror (110, 111) or to another source, such as ground (not shown). The current is directed by a control signal(s) (108A, 108B) provided to switches 106, 107 associated with the mirrored current sources 103, 104.

The first current source 102 produces a current 112 that is equal to a reference current I_{Ref} provided at input node 101. The current 112 is maintained as I_{Ref} by the feedback loop formed between the first current source 102, switch 105, and operational amplifier 109. The voltage at the current mirror input 101 is sensed and the differential signal of the terminals of the operational amplifier 109 is amplified producing voltage Vₒ. Voltage Vₒ is provided as a voltage control signal to the current source 102 and to all of the mirrored current sources 103, 104. Thus, the current produced by each current source is a multiple Of I_{Ref}. For example, the current sources may produce a current that is 1×, 2×, 5×, 0.5× of I_{Ref} depending on the size of the mirrored current source relative to the size of the first current source 102. The voltage control signal (108A, 108B) causes the current sources 103, 104 to produce the desired output current (110 or 111). As shown, there are two separate current outputs 110, 111. In some embodiments there may be more than two outputs and in other embodiments there may only be a single output. If there is only one output, the switches 106, 107 when switched to couple the mirrored current sources 103, 104 to the output will cause the currents 113, 114 to be summed at the output. In embodiments where there are two or more outputs, one or more mirrored current sources may contribute to one output and the same or different mirrored current sources may contribute to a second output wherein the control signals cause the switches 106, 107 to switch between the outputs.

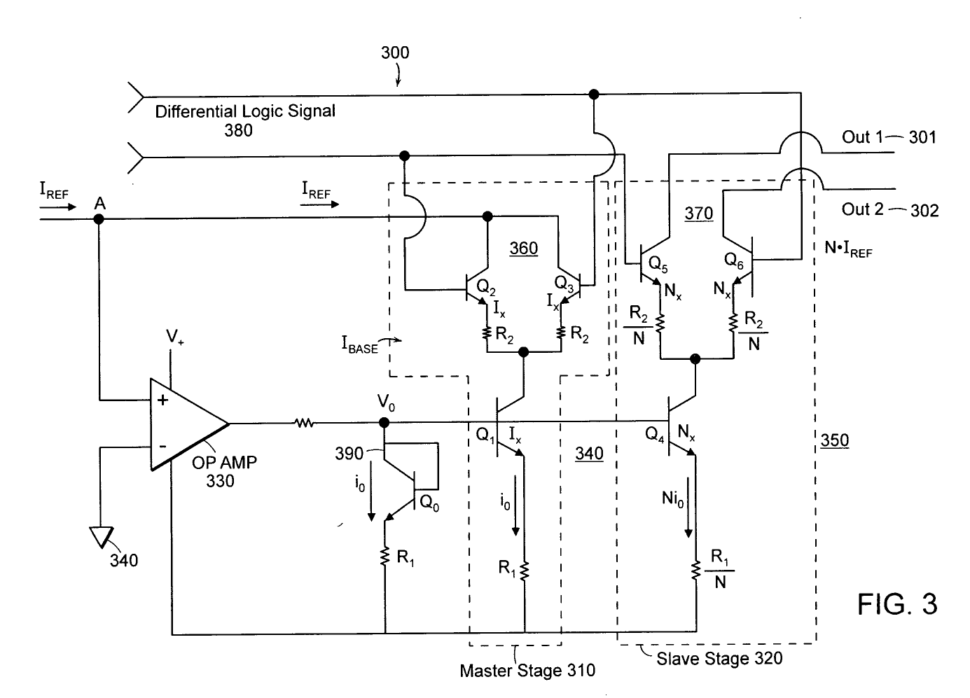

FIG. 3 is a circuit schematic showing a first embodiment of a switchable current mirror with feedback 300. The current mirror can be switched between a first output out1 301 and a second output out2 302. The circuit includes a master stage 310, a slave stage 320 and an operational amplifier 330. The transistors Q₄, Q₅, and Q₆ in the slave stage are sized to be N times as large as the transistors Q₁, Q₂, and Q₃ in the master stage. By sizing the transistors and reducing the size of the resistors R₁/N, R₂/N in the slave stage 320, the slave stage 320 will produce a current Niₒ that is N times the current iₒ of the master stage 310. Similarly, if the transistors Q₄, Q₅, and Q₆ in the slave stage are decreased by a multiple of the size of the master stage Q₁, Q₂, and Q₃ and the resistors R₁, R₂ in the slave stage are increased by the same multiple, a fraction of the current from the current source in master stage will be produced by the current source in the current source of the slave stage.

At the input node marked A a reference current I_{Ref} is introduced. The voltage at node A is presented to a first input terminal of the operational amplifier 330 which in this embodiment is the positive terminal. The negative terminal is coupled to a reference voltage, which in this embodiment is ground 340. It should be recognized by those skilled in the art that the operational amplifier is configured as an inverting operational amplifier. The operational amplifier produces an amplified output voltage. This output voltage results in voltage Vₒ. The voltage Vₒ is applied to the base of bipolar transistor Q₁ of the master stage 310 and to the base of bipolar transistor Q₄ of the slave stage 320. In the present example, bipolar transistor Q₄ is sized to be N times the size of transistor Q₁. For proper operation of the current mirror circuit, Voltage Vₒ is set to be greater than the voltage required V_{be} to turn on the base emitter junction of the bipolar transistors (Q₁ and Q₄). As shown, a resistor R₁ is coupled between the emitter of Q₁ and the negative voltage supply rail V− and a resistor R₁/N is coupled between the emitter of Q₄ and the negative voltage supply rail V−. Thus, both Q₁ and Q₄ cause current to flow in their respective stages through their respective resistors and these transistors operate as controllable current sources 340, 350.

In addition, to the current sources, both the master and slave stages include a switch 360, 370. In the embodiment that is shown, each switch 360, 370 is a differential bipolar transistor pair. Other field effect transistors may be substituted without deviating from the intent of the invention. The switches of the master stage 310 and the slave stage 320 are both controlled by a differential logic signal 380. In one embodiment, the differential logic signal 380 is a 400-800 mV peak-to-peak single ended signal at a common mode of V−+ (2V or more). By providing a logic signal 380 the bipolar transistor pair within a stage operates like a switch wherein one of the bipolar transistors is on and the other bipolar transistor is off. In other embodiments, if operation in the linear region is desired, the control signal to the differential transistor pair may be such that both transistors of the differential pair are turned partially on.

The differential transistor pair of the master stage includes bipolar transistor Q₂ and Q₃ wherein the control signal/logic signal 380 is fed into the base of the transistors. The collectors of both Q₂ and Q₃ are electrically coupled to the input node A and complete a feedback loop with the operational amplifier 330. By closing the feedback loop the current coming out of the collectors of either Q₂ or Q₃ is always equal to I_{Ref}.

The differential transistor pair of the slave stage 320 includes bipolar transistors Q₅ and Q₆ wherein the control signal/logic signal 380 is fed into the base of the transistors. As previously noted Q₅ and Q₆ are sized at some multiple N of the size of the transistors in the master stage. The collector of transistor Q₅ is coupled to the output out1 301 and produces a current that is N·I_{REF}. The collector of transistor Q₆ is coupled to the output out2 302 and also produces a current that is N·I_{REF}. Thus, the current produced by transistor Q₁ is mirrored by Q₄ and is N times that of the current passing through Q₁.

In addition to the master stage 310, the slave stage 320, and the operational amplifier 330, a resistor Rₒ and a diode 390 (formed from transistor Qₒ by attaching the base and collector) may be included in the circuit to help stabilize the feedback loop and to provide a precise base voltage Vₒ for Q₁ and Q₄.

The feed back loop guarantees that I_{ref} will be the current flowing through either the collector of Q₂ or Q₃ and therefore, the current at the collector of Q₁ will be Iₒ=I_{ref}+I_{base}. As a result, the mirrored current in the slave stage through Q₄ will be a multiple of Iₒ. The multiple depends on the ratio between the areas of transistors Q₁ and Q₄. Thus, the current flowing out of the collector of Q₅ or Q₆ will be N·Iₒ+N·I_{base} which is equivalent to N·I_{REF}. By providing the proper logic signal to the present circuit, current can be directed to one of the plurality of outputs. It should be understood by those of ordinary skill in the art that additional slave circuits could be added either in parallel, thereby allowing for varying the output current at an output or in series wherein there would be multiple outputs.

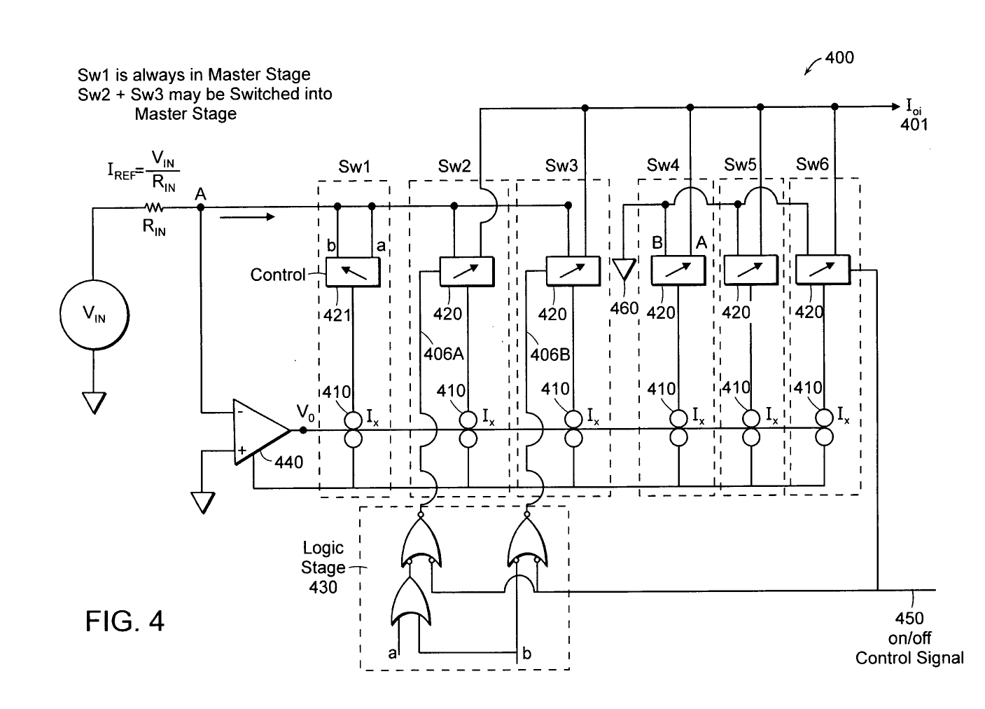

FIG. 4 is a circuit schematic showing a second embodiment of a switchable current mirror with feedback 400. In this embodiment of the invention, there is only a single output 401 and the slave stage includes multiple sub-circuits (at least SW2, SW3, SW4, SW5, and SW6) that can be programmed to contribute to either the output current or to the current present within the feedback loop. Each sub-circuit includes a current source 410 and a switch 420 for directing the current. The switchable current mirror 400 of this embodiment has a logic stage 430 for directing current from the slave sub-circuits (SW2, SW3) current source 410 either to the output 401 of the current mirror or back to the input node A. As shown in FIG. 4, the controls and control signals provided to the switches of the master stage and the sub-circuits of the slave stage are single ended. This is done for simplicity and it should be understood that the switches can be differential switches that would receive differential control signals.

As in the embodiment of FIG. 3 a reference current is provided at an input node of the circuit (Node A). The reference current is generated by the voltage source Vᵢₙ and the resistor Rᵢₙ where the reference current

$${I}_{ref} = \frac{{V}_{i n}}{{R}_{i n}} .$$

Other means for generating a reference current may be substituted. The voltage at node A is sensed by the operational amplifier 440. The operational amplifies the differential voltage between node A and ground producing voltage Vₒ. The voltage Vₒ is provided to the controllable current source 411 of the master stage and to each of the current sources 410 of the slave stage's sub-circuits. As a result of the base voltage, the current sources produce a current. As shown, each current source is sized to produce a current that is 1×. The master stage SW1 preferably includes a switch 421 that is always within the feedback loop that couples the current source of the master stage to an input terminal of the operational amplifier. The switch 421 is included so that the master stage is substantially similar to the sub-circuits of the slave stage and exhibits the same electrical properties. As a result, the current mirror produces a more accurate output current that is a multiple or fractional multiple of the reference current. As shown in the Fig., the switch 421 of the master stage SW 1 receives a switching signal which switches the switch to either connection “a” or connection “b”. As previously stated, both connections “a” and “b” are fed back to node A and to the operational amplifier 440. The master stage SW1 produces the current that is mirrored in the slave stages SW2, SW3, SW4, SW5, and SW6. If the current source of the master stage SW1 is the only current source that is fed back, then the mirror current will be equal to the current produced by the current source SW1 of the master stage. As explained below, other current sources may be switched into the feedback loop with the current source of the master stage and as a result the mirror current in the sub-circuits of the slave stage will change.

The switching of the current mirror operates in the following manner. All of the current sources are assumed to produce the same current which will be referenced as 1×. In other embodiments, the current sources may be sized differently and produce different currents. An on/off signal 450 is provided to the current mirror. The ON signal causes the switches 420 of sub-circuits SW4, SW5, and SW6 to direct the current from their respective current sources to the current mirror output. If on OFF signal is sent, the three switches of sub-circuits SW4, SW5, and SW6) direct the current from the current sources to ground 460 or another lower potential.

The logic stage 430 of the current mirror directs a control signal to switches 420 in sub-circuits SW2 and SW3. As a result of the combination of control signals including the ON/OFF signal 450 and the input signals into the logic stage (a,b), the output current can be varied between 1×, 2× and 5× in this embodiment. It should be noted that the switch of the master stage SW1 is always fed back to the operational amplifier.

In order to obtain 5× at the output 401 of the current mirror 400, the ON/OFF signal 450 is ON and the input signals to the logic stage “a” and “b” are equivalent to a logic one. As a result, the switches in SW2 and SW3 direct the current from their respective current sources to the output. The output current at the current mirror output is a summation of the current source currents from SW2, SW3, SW4, SW5 and SW6 and therefore 5×.

If the desired output current for the current mirror is 2×, the ON/OFF control signal is set to an ON state and therefore SW4, SW5, and SW6 provide the current from their current sources to the output. The input signals “a” and “b” to the logic stage are set such that “a” is a logic one and “b” is a logic zero. The signals 460a, 460b result in the switch of SW2 switching the current of its current source into the feedback loop of the master stage SW1. Thus, SW1 and SW2 are part of the master stage, and therefore, the master current is 2×. The input signals “a” and “b” also cause the switch of SW3 to direct the current of its current source to the output. The resulting current at the output is thus the ratio of current in the feedback loop of the master stage divided by the current directed to the output which is 2. Each of the current sources that are present in the slave stage are one half the size of the combined current sources of SW1 and SW2 and therefore, the current sources of these slave stages (SW3, SW4, SW5, and SW6) each produce a current that is equal to half of the current produced by one of the current sources in the feedback loop (i.e. master stage).

If an output current at the output 401 of the current mirror 400 is desired to be 1×, the ON/OFF control signal 450 is set to ON and the control signals “a” and “b” are set so that “a” and “b” both equal a logic zero. The logic stage causes, the switches of SW1, SW2, and SW3 to switch so that the current sources of the respective sub-circuits are within the master stage. Additionally, the ON signal causes SW4, SW5, and SW6 to be coupled to the output of the current mirror. Thus, the ratio of the current sources is equal to 1 and the output current is 1×.

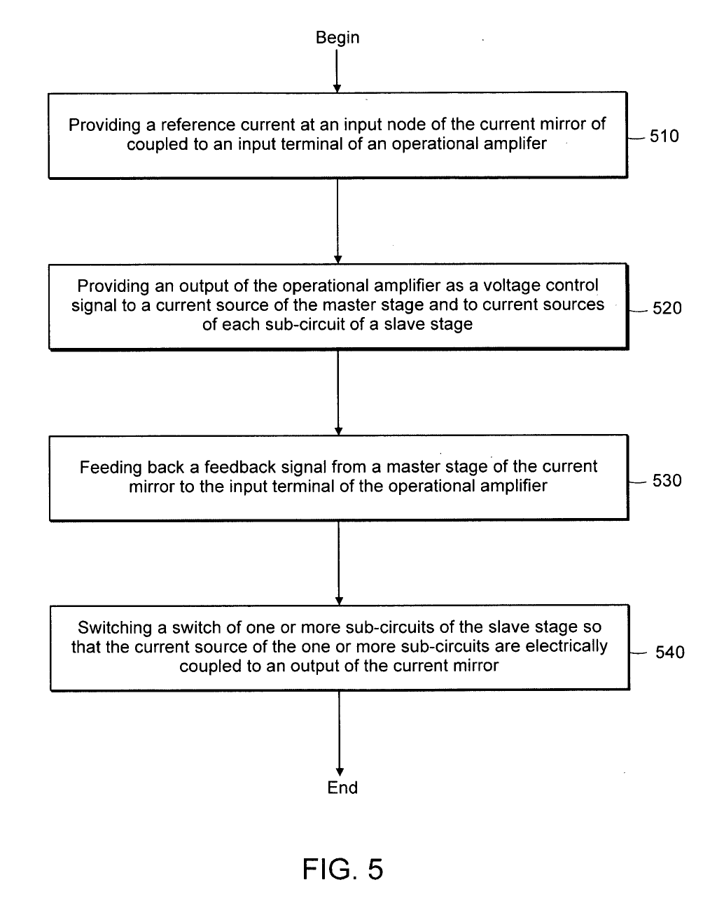

FIG. 5 is a flow chart explaining the methodology for selecting a current at a current mirror output. The methodology may be applied to the embodiments shown in FIGS. 2, 3, and 4. First, a reference current is provided to the input node of the current mirror (510). The input node of the current mirror is coupled to one of the input terminals of an operational amplifier. The operational amplifier is used as part of a feedback loop in order to stabilize the current produced by the master stage of the current mirror. The operational amplifier senses the voltage at the input node and amplifies the differential signal between its inputs. The output of the operational amplifier is provided to a current source of the master stage, such as to the base of a bipolar transistor, as a voltage control signal (520). This voltage control signal is also provided to current sources in each of the sub-circuits of the slave stage. Again, the signal may be provided to the base of bipolar transistors that form part of the current source in each of the sub-circuits of the slave stage. The master stage feeds back a feedback signal (voltage/current) to the input node and therefore, to the input terminal of the operational amplifier (530). A switch is added into the master stage, so that the master and slave stages have the same electrical components and therefore exhibit the same electrical characteristics. The feedback signal causes the current through the current source of the master stage to equate to the reference current at the output of the switch of the master stage. The current produced by the master stage's current source is mirrored at the current source of each sub-circuit of the slave stage. As a result, each current source of a sub-circuit in the slave stage will produce a current at the output of an associated switch that is a multiple of the reference current. The multiple depends on the relative size differential between the current source of the master stage and the mirroring current sources of the sub-circuits of the slave stage. A control signal is provided to one or more of the switches within the sub-circuits. The control signal causes at least some of the switches of the slave stage to connect their respective current source with an output of the current mirror. The current sources will sum at the output and will be a multiple of the input reference current. The reference current will be mirrored with a high degree of precision that is greater than that provided by prior art embodiments. Additionally, because the circuitry can be implemented with bipolar transistors switching between outputs and current levels at the outputs can be accomplished at nanosecond switching speeds.

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

What is claimed is:

1. A current mirror comprising:
an input for receiving an input reference current;
an operational amplifier having at least a pair of input terminals and an output terminal, at least one input terminal electrically coupled to the input;
a master stage including a current source producing a current source current, the master stage electrically coupled to the output terminal of the operational amplifier, the master stage including a feedback loop feeding back a feedback signal to at least one input terminal of the operational amplifier; and
a slave stage having a current source configured to receive an output from the output terminal of the operational amplifier, the slave stage configured to receive a control signal for selecting between at least a first output state and a second output state.

2. The current mirror according to claim 1, wherein the master stage includes a switch controllable by the control signal.

3. The current mirror according to claim 2, wherein the switch has a plurality of outputs and wherein each of the outputs is coupled to the one terminal of the operational amplifier.

4. The current mirror according to claim 1, wherein the slave stage includes at least one switch controllable by the control signal.

5. The current mirror according to claim 1, wherein the slave stage comprises a plurality of sub-circuits wherein each sub-circuit includes a current source coupled to the operation amplifier and each sub-circuit also includes a switch for switching between at least a first and a second output state.

6. The current mirror according to claim 5, further comprising:
control logic for producing a control signal for selection of one or more of the slave stage sub-circuits.

7. The current mirror according to claim 4, wherein the current source of the slave stage includes a transistor having a size that is a multiple of the size of a transistor in the current source in the master stage.

8. The current mirror according to claim 1 wherein the master stage includes a switch composed of a differential transistor pair.

9. The current mirror according to claim 1 wherein the slave stage includes a switch composed of a differential transistor pair and wherein the control signal is a differential signal.

10. The current mirror according to claim 9, wherein in a first state the switch of the slave stage feeds back current from the programmable current source to the operational amplifier and wherein in the second state the current from the programmable current source is directed to an output.

11. The current mirror according to claim 1 wherein the current sources in the master and slave stages are controllable current sources and an output signal from the operational amplifier is used to control the current sources in the master and slave stages.

12. A current mirror comprising:
a master stage including an input for receiving an input current, a current source controlled by a current source signal, and a differential switching pair having an output which is fed back to the input; and
a slave stage including a current source controlled by the current source signal and at least one differential switching pair including at least one output wherein current output from the slave stage is equal to a multiple of the input current.

13. The current mirror according to claim 12, further comprising an operational amplifier having an output electrically coupled to the current sources of the master and slave stages.

14. The current mirror according to claim 13, wherein the current source of the master and slave stages each include a bi-polar transistor and the output of the operational amplifier is coupled to the base of both bi-polar transistors.

15. The current mirror according to claim 12, wherein the differential switching pair receives a control signal for either directing current from the current source of the slave stage either to a current mirror output or to a location internal to the current mirror.

16. A method for selecting an output current at an output in a current mirror, wherein the current mirror includes an operational amplifier, a master stage including a switch and a slave stage having a plurality of sub-circuits, each sub-circuit including a switch, the method comprising:
providing a reference current to an input terminal of the operational amplifier;
feeding back a feedback signal from the master stage to the input of the operational amplifier; and
switching the switch of one or more sub-circuits of the slave stage so that a current source of the one or more sub-circuits is electrically coupled to an output of the current mirror.

17. The method according to claim 16, wherein switching includes providing a control signal to the switch of one or more sub-circuits of the slave stage.

18. The method according to claim 17,
providing an output of the operational amplifier as a voltage control signal to a current source of the master stage and to the current sources each sub-circuit of the slave stage.

19. The method according to claim 16 further comprising switching a control signal of at least one of the sub-circuits of the slave stage so that the sub-circuits contribute to the feedback signal.
